(19) United States
(12) Patent Application Publication
(10) Pub. No.: US 2012/0262568 A1
(43) Pub. Date: Oct. 18, 2012

(54) Camera for monitoring machine functions of a vehicle and method of using the camera

(76) Inventor: Dirk Ruthenberg, Bad Essen (DE)

(21) Appl. No.: 13/443,270

(22) Filed: Apr. 10, 2012

(30) Foreign Application Priority Data
Apr. 15, 2011 (DE) 10 2011 002 111.6

(51) Int. Cl. H04N 7/18

(52) U.S. Cl. 348/89; 348/148; 348/E07.085

(57) ABSTRACT

A camera (1) for monitoring machine functions of a vehicle may be disposed on or in the vehicle. The camera is constructed with a housing containing a lens and a first pane disposed in front of the lens. The first pane protects the lens against environmental influences. A heating element is disposed in the housing adjacent to the first pane.

### CROSS-REFERENCE TO A RELATED APPLICATION

The invention described and claimed hereinbelow is also described in German Patent Application DE 10 2011 002111.6, filed on Apr. 15, 2011. The German Patent Application, whose subject matter is incorporated by reference herein, provides the basis for a claim of priority of invention under 35 U.S.C. 119(a)-(d).

### BACKGROUND OF THE INVENTION

The present invention relates to a camera for monitoring machine functions of a vehicle and a method for using the camera on a self-propelled harvesting machine.

The use of a camera to monitor machine functions of a vehicle has been known for a long time. For example, EP 1344445 A1 describes the use of a camera to monitor the orientation of an upper discharge chute of a self-propelled forage harvester with respect to an accompanying vehicle that receives crop. It is known from EP 1916126 B1 to use a camera to support the coupling procedure between a combine harvester and a header trailer while the combine harvester backs up toward the header trailer. EP 1763988 A1 describes the use of a camera in the grain elevator of a combine harvester for assessing the quality of the conveyed crop. The quality-related information is used to adjust the machine parameters.

When a camera is used, limitations can result if weather conditions are unfavorable, due to moisture condensing on the pane that protects the lens from environmental influences such as moisture or contamination. This impairs the quality of the images that are captured by the camera and displayed on a screen, thereby impairing the monitoring function.

### SUMMARY OF THE INVENTION

The present invention provides a camera for monitoring machine functions of a vehicle and method for using the camera on a self-propelled harvesting machine, which overcome the aforementioned disadvantages.

In an embodiment, the invention provides a camera for monitoring machine functions of a vehicle. The camera is disposed on or in the vehicle. The camera comprises a housing containing a lens and a first pane disposed in front of the lens in order to protect the lens against environmental influences. At least one heating element is disposed in the housing, adjacent to the first pane. By way of the at least one heating element, moisture condensation on the first pane caused by a drop in temperature relative to the surroundings is prevented.

Preferably, a second pane is detachably disposed on the housing, on the side of the first pane facing away from the lens, at a distance therefrom. The second pane serves to protect the pane lying underneath, tightly sealing the space of the housing enclosing the lens with respect to the surroundings and preventing moisture or air from entering.

The use of known cameras under conditions that would result in strong contamination and even wear of the surface of the first pane due to the abrasive effect of the crop under crop harvesting conditions or manual cleaning of the first pane may require replacing the pane entirely. In the inventive camera, however, use of the second pane makes it possible to manually remove contaminants on the second pane and, if necessary, to replace the second pane if the wear of the surface caused by cleaning or the abrasive effect of the crop has become too great. To this end, the second pane is mounted in an interchangeable frame. The interchangeable frame makes it possible to easily install and remove the second pane for cleaning or replacement.

Advantageously, the second pane can be designed as a filter. To this end, depending on the light conditions, the second pane can be replaced by a pane that is tinted to an extent that is appropriate for the prevailing light conditions. Alternatively, a self-tinting pane that automatically changes the degree of light permeability depending on the light conditions may be used.

At least one outlet opening is provided on a frame holding the first pane and/or on the interchangeable frame, through which a fluid can be output onto the surface of at least one of the two panes in a directed manner. The at least one outlet opening is disposed on the frame or the interchangeable frame in such a way that a directed fluid stream is output over the surface of at least one of the two panes. By way of the fluid that flows over the surface, contaminants collecting on the first pane or the second pane can be removed, at least in part. Preferably, water or compressed air can be used as the fluid.

Preferably, a continuous stream of fluid can be output through the at least one outlet opening. The output of a continuous stream of fluid forms a type of curtain in front of the first pane or the second pane, thereby making it possible to largely prevent small crop particles such as dust from depositing onto the surface. The use of compressed air as the fluid is the most favorable variant.

Advantageously, the interchangeable frame is connected to the housing in a positive and/or non-positive manner, and is detached therefrom without being destroyed. A threaded connection is particularly advantageous for making such detachable connection. A clip connection also is feasible, but the invention is not limited to a threaded of clip connection.

Also, at least one heating element can be electrically operated in the camera, which is a low-cost, space-saving variant. The at least one heating element comprises one or more resistors disposed on a substantially annular insertion component adapted to the cross section of the housing. The at least one heating element may be disposed in the interior of the housing in the region of the first pane. The insertion component can be designed as one piece or multiple pieces depending on the complexity of the design in the interior of the housing of the camera.

Preferably, the temperature of the at least one heating element is controlled or regulated. It is therefore possible to react to temperature changes in the surroundings within a specifiable temperature range in which the at least one heating element is intended to be operated.

To achieve sufficient thermal conduction between the at least one heating element and the first pane, a frame holding the first pane that is connected to the at least one heating element is made of a metal at least in sections.

Advantageously, the frame holding the first pane is connected to the second pane. As a result, heat also is transferred to the second pane and to the space between the first pane and the second pane, thereby making it possible to prevent moisture from condensing between the first pane and the second pane and on the outer side of the second pane.

Moreover, the invention includes a method for using camera on a self-propelled agricultural harvesting machine that comprises a transfer device for transferring crop to an accompanying vehicle, where the transfer device is swiveled between a transfer position and a road-travel position.

For example, the camera is disposed on the transfer device, wherein, depending on the position of the transfer device, the camera transmits images of the transfer of the crop or of the rear region of the harvesting machine to a video screen unit.

When the transfer device is in the road-travel position, the camera transmits images of the rear region of the harvesting machine to the video screen unit, the images being dependent on the direction of travel. The camera may be activated when the reverse gear is selected, in order to provide the driver with images of the rear region and thereby simplify the backing-up process and ensure the safety thereof.

Moreover, when the transfer device is in the road-travel position, a time delay can be implemented in the shut-off of the camera when the direction of travel is switched from reverse travel to forward travel. The purpose of the time delay in shutting off the camera is to ensure that the driver receives images of the rear region of the harvesting machine during a transition phase when switching from reverse travel to forward travel, in order to show the driver any obstacles that may suddenly appear in the rear region during said transition phase.

### BRIEF DESCRIPTION OF THE DRAWING FIGURES

Further features and advantages of the invention will become apparent from the description of embodiments that follows, with reference to the attached figures. Shown are:

FIG. 1 is a perspective view of a camera according to the invention;

FIG. 2 is a schematicized partial sectional view of a housing of the camera according to FIG. 1;

FIG. 3 is a perspective view of a forage harvester from the rear; and

FIG. 4 is a schematic side view of a combine harvester.

### DETAILED DESCRIPTION OF THE PREFERRED EMBODIMENTS

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

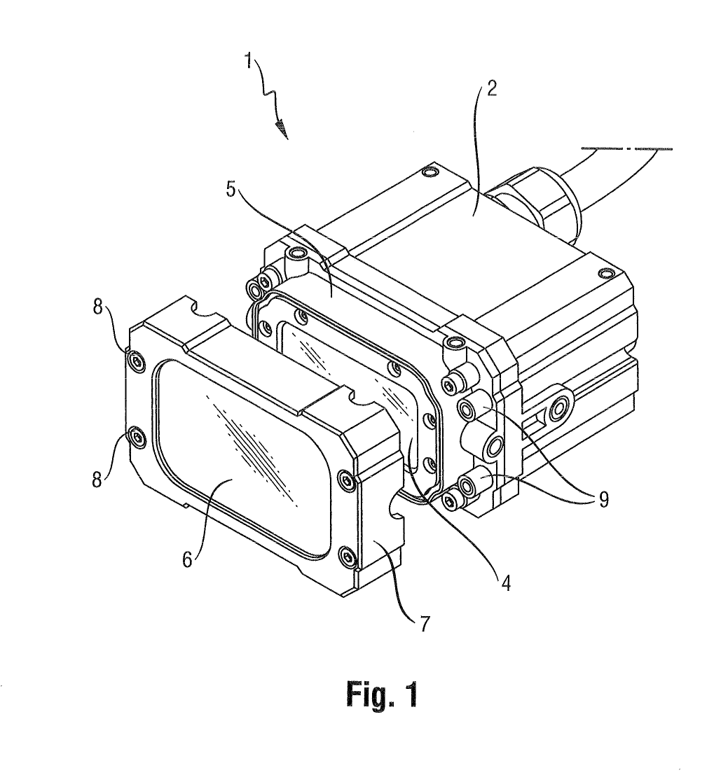

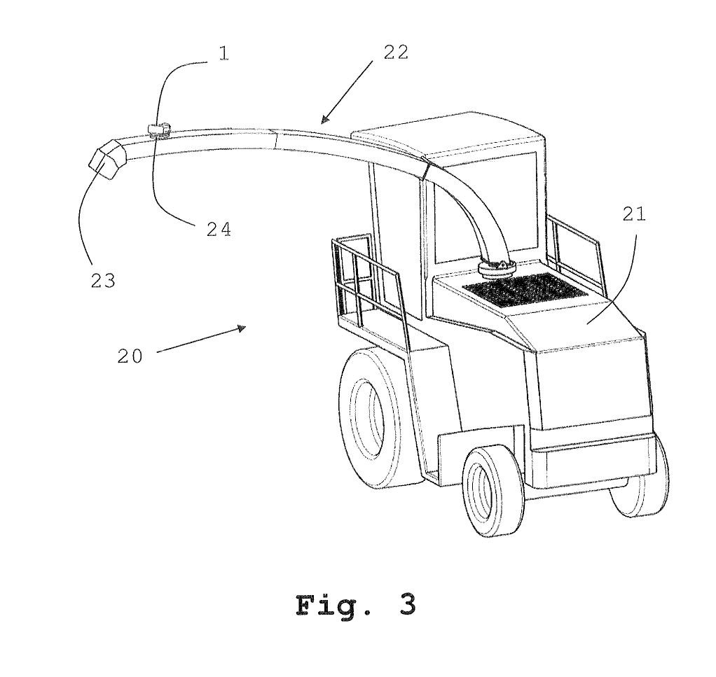

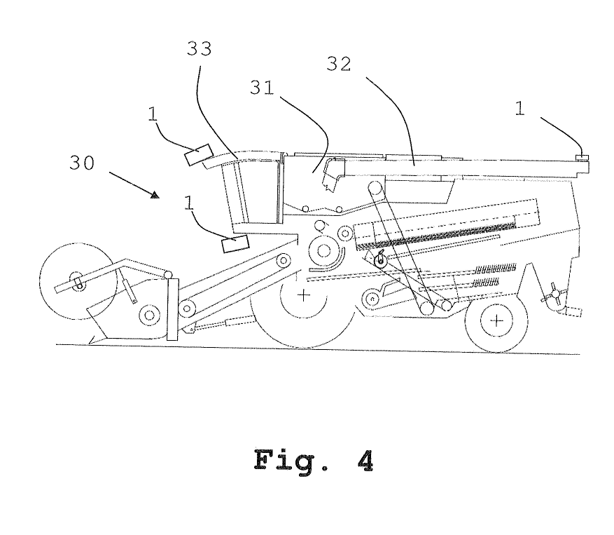

FIG. 1 depicts a perspective view of a camera 1 of the type that can be used to monitor machine functions of a vehicle. To this end, the camera 1 is disposed on or in the vehicle, in accordance with machine functions to be monitored, as will be explained as an example with reference to FIGS. 3 and 4, which show a forage harvester and a combine harvester, respectively. The camera 1 comprises a housing 2, which is tightly sealed on one side by a frame 5 and a first pane 4 held therein. Moreover, the depiction according to FIG. 1 shows an interchangeable frame 7 comprising a second pane 6, in a position in which it has been removed from the housing 2 of the camera 1. The interchangeable frame 7 can be connected to the housing 2 by threaded connections, as indicated by the screws 8 and the threaded holes 9.

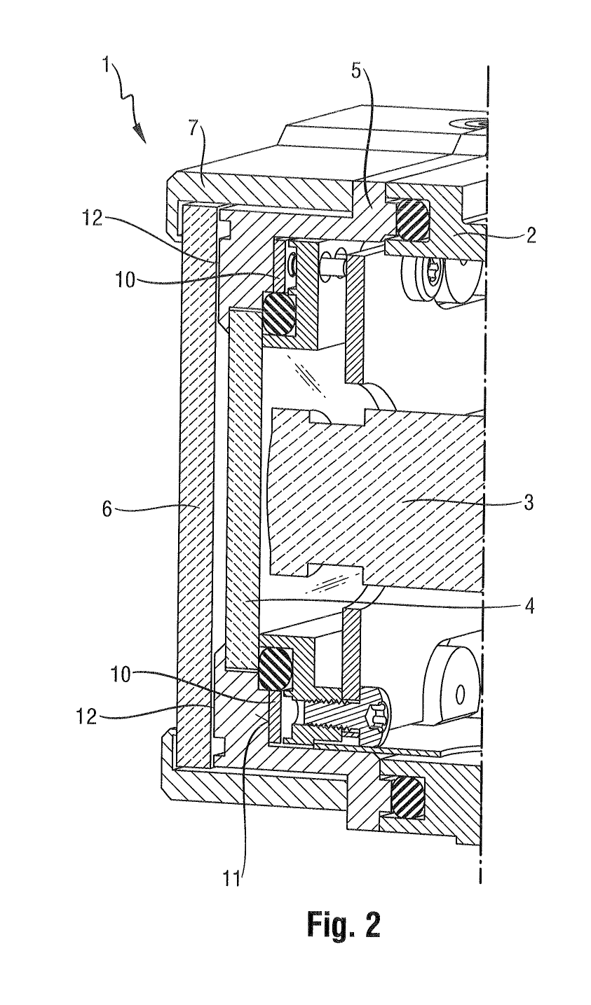

FIG. 2 depicts a schematicized sectional view of the housing 2 of the camera 1 according to FIG. 1. A lens 3 and associated electronics (not shown) are disposed in the housing 2. As described above, the housing 2 is closed by a first pane 4, which is non-detachably held in a frame 5, in order to prevent dust or moisture from entering the housing 2. The frame 5 enclosing the first pane 4 is made of a material, at least in sections, that is characterized by good thermal conductivity. In particular, the section 12 of the frame 5 that directly encloses the first pane 4 is made of such a material.

The second pane 6 in the interchangeable frame 7 is disposed adjacent to the first pane 4. The interchangeable frame 7 is detachably connected to the housing 2 by way of a positive and/or non-positive connection.

At least one heating element 10 is disposed adjacent to the first pane 4 in the interior of the housing 2. The heating element 10 is electrically operated and comprises one or more resistors for generating the dissipation heat required for heating. The temperature of the at least one heating element 10 can be controlled or regulated in response to changing environmental conditions. An external temperature probe could deliver a comparative value for this purpose, which is used as the basis for adjusting the at least one heating element 10. The frame 5 holding the first pane 4, which is connected to the at least one heating element 10, is preferably made of a metal, at least in the region 11 thereof that contacts the heating element 10, in order to achieve the most efficient transfer of heat possible between the frame 5 and the heating element 10. As shown in FIG. 2, the second pane 6 is placed adjacent to the first pane 4, and a small air gap forms therebetween. To achieve a loss-free transfer of heat from the at least one heating element 10 to the second pane 6 as well, heat is preferably transferred by way of the section 12 of the frame 5 of the first pane 4 against which the second pane 6 lies in sections. This section, at the least, is therefore made of a material having good thermal conductivity.

FIG. 3 depicts a forage harvester 20 in a perspective view from the rear. The front side of the forage harvester 20, which faces away from the observer, comprises a feeder housing, which is known per se, on which different types of front attachment devices can be mounted in a replaceable manner. The front attachment devices differ in terms of the type of crop for which they are designed, and or in terms of the working width thereof. The front attachment feeds the crop to a chopping mechanism in the interior of the body 21 of the forage harvester 20. An upper discharge chute 22 is mounted on the top side of the body 21 in such a way that it can rotate about a vertical axis, and is shown in a discharge position. The upper discharge chute 22 is used to transfer the chopped crop into an accompanying vehicle traveling parallel to the forage harvester 20. The proximal section of the upper discharge chute 22 is rotatably connected to the body 21, and the distal section of the upper discharge chute 22 carries a discharge flap 23 on the end thereof opposite the body.

The camera 1 is mounted on the distal section of the upper discharge chute 22, adjacent to the discharge flap 23. The camera 1 is connected to the distal section by way of a flexible coupling 24 having a vertical axis of rotation. A motor mounted at the flexible coupling 24 is coupled to a rotary drive of the upper discharge chute 22. The camera 1 is used, for example, for function monitoring during the discharge process to the accompanying vehicle.

For road travel, the upper discharge chute 22 is transferred into a road-travel position, that is, the upper discharge chute 22 is located in a position parallel to the longitudinal axis of the forage harvester 20. In the road-travel position, the camera 1 at the upper discharge chute delivers images of the rear region of the forage harvester 20 to a video screen unit in the interior of the driver's cab.

FIG. 4 depicts a schematic side view of a combine harvester 30. The combine harvester 30 comprises a header in the front region thereof. The header serving to harvest and pick up crop and transfer same to the combine harvester 30 for further processing. The crop material is processed in the combine harvester 30, wherein grain separated out of the pick-up crop is conveyed into a grain tank 31. The grain stored in the grain tank 31 is transferred to an accompanying vehicle by way of a grain tank discharge pipe 32 when the maximum holding capacity is reached. The camera 1 is mounted on the grain tank discharge pipe 32 to monitor the transfer process. The camera is used under difficult conditions in this case.

In particular, fine dust particles can deposit on the surface of the first pane 4 or the second pane 6 and result in considerable impairment of the image quality of images captured by the camera 1 for monitoring purposes. This impairment is worsened by moisture condensing on the surface of the first pane 4 or the second pane 6. The use of the camera 1 comprising at least one heating element 10 disposed in the housing 2 makes it possible to maintain image quality over a longer period of time without manual cleaning. Since, as described above, manual cleaning would result in damage to the surface of the first pane 4 over the long term by making it dull, it makes sense to use a second pane 6, which can be easily detached from the housing 2 for cleaning and can be replaced in its entirety if necessary.

FIG. 4 depicts further positions of a possible placement of the camera 1 on the outer side of the harvesting machine for monitoring machine functions. That is, FIG. 4 shows camera 1 is disposed on the roof of the cab 33 enabling the camera to look into a field to be harvested and thereby provide information about the crop quantity to be picked up. In addition, another camera 1 is disposed underneath the cab 33 as indicated and looks into the header trough and provides data on the distribution of the crop taken up by the header and display the captured data on a video screen unit in the cab 33. If an existing or additional camera 1 is used in the interior of the combine harvester, the camera could be mounted in the engine compartment or at the point at which straw is transferred to a chopping unit, for example.

The camera 1 mounted on the grain tank discharge pipe 32 is used, depending on the position of the grain tank discharge pipe 32, either as a back-up camera or to monitor the discharge process, wherein, depending on the position of the grain tank discharge pipe 32, the camera 1 transmits images of the transfer of the crop to the accompanying vehicle or images of the rear region of the combine harvester 30 to a video screen unit in the cab 33. The transmission of the images can continue, with time delay, when a switch is made from reverse travel to forward travel to ensure that images of the rear region of the harvesting machine are continuously provided during the first period of time after the direction of travel is changed.

The following list of identifiers of various elements and references is included (as follows), for ease of explanation:
1 Camera
2 Housing
3 Lens
4 First pane
5 Frame
6 Second pane
7 Interchangeable frame
8 Screw
9 Threaded hole
10 Heating element
11 Contact surface
12 Section
20 Forage harvester
21 Body
22 Upper discharge chute
23 Discharge flap
24 Flexible coupling
30 Combine harvester
31 Grain tank
32 Grain tank discharge pipe
33 Cab

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A camera (1) for monitoring machine functions of a vehicle (20, 30), the camera (1) is disposed on or in the vehicle (20, 30) and comprising a housing (2) containing a lens (3) and a first pane (4) disposed in front of the lens (3), which protects the lens (3) against environmental influences, wherein at least one heating element (10) is disposed in the housing (2), adjacent to the first pane (4).

2. The camera (1) according to claim 1, wherein a second pane (6) is detachably disposed on the housing, on the side of the first pane (4) facing away from the lens (3), at a distance therefrom.

3. The camera (1) according to claim 2, wherein the second pane (6) is held in an interchangeable frame (7).

4. The camera (1) according to claim 2, wherein the second pane (6) is designed as a filter.

5. The camera (1) according to claim 2, wherein at least one outlet opening is provided on a frame (5) holding the first pane (4), on the interchangeable frame (7), or both, through which a fluid can be output onto the surface of at least one of the two panes (4, 6) in a directed manner.

6. The camera (1) according to claim 5, wherein a continuous stream of fluid can be output through the at least one outlet opening.

7. The camera (1) according to claim 3, wherein the interchangeable frame (7) is connected to the housing (2) in a non-positive or positive manner, and is detached therefrom without being destroyed.

8. The camera (1) according to claim 1, wherein the at least one heating element (10) is electrically operated.

9. The camera (1) according to claim 1, wherein the at least one heating element (10) comprises one or more resistors.

10. The camera (1) according to claim 1, wherein the temperature of the least one heating element (10) can be controlled or regulated.

11. The camera (1) according to claim 5, wherein the frame (5) holding the first pane (4), which is connected to the at least one heating element (10), is made of a metal.

12. The camera according to claim 11, wherein the frame (5) is connected to the second pane (6).

13. A method of using a camera (1) on a self-propelled agricultural harvesting machine (20, 30) with a transfer device (22, 32) for transferring crop to an accompanying vehicle, wherein the transfer device is swiveled between a transfer position and a road-travel position, and wherein the camera (1) comprises a housing (2) containing a lens (3) and a first pane (4) disposed in front of the lens (3), which protects the lens (3) against environmental influences, wherein at least one heating element (10) is disposed in the housing (2), adjacent to the first pane (4), the method comprising the steps of:
disposing the camera (1) on the transfer device (22, 32); and
transmitting images of the transfer of the crop or of the rear region of the harvesting machine (20, 30) to a video screen unit by the camera (1) depending on the position of the transfer device (22, 32).

14. The method according to claim 13, wherein the step of transmitting includes that the camera (1) transmits images of the rear region of the harvesting machine (20, 30) to the video screen unit depending of a direction of travel when the transfer device is in the road-travel position.

15. The method according to claim 14, wherein a time delay is implemented in the shut-off of the camera (1) when the direction of travel is switched from reverse travel to forward travel when the transfer device is in the road-travel position.
